(19) United States
(12) Patent Application Publication
(10) Pub. No.: US 2005/0021459 A1
(43) Pub. Date: Jan. 27, 2005

(54) System for electronic payment and monitoring of fees

(76) Inventor: John David Bell, Dunedin (NZ)

Correspondence Address: Peter C Lauro;Edwards & Angell, PO Box 55874, Boston, MA, 02205, US

(21) Appl. No.: 10/487,530

(22) PCT Filed: Aug. 30, 2002
(86) PCT No.: PCT/NZ02/00170

(30) Foreign Application Priority Data
Aug. 31, 2001 (NZ) 513910

(51) Int. Cl. G06F 17/60

(52) U.S. Cl. 705/40

(57) ABSTRACT

A system for the payment and monitoring of fees which includes a personal device carried by a user and a monitoring device which communicates with the personal device to confirm/ascertain that the personal device has been activated to deduct the required fee.

### FIELD OF THE INVENTION

The invention relates to a system for the payment and monitoring of fees.

The system will be described with reference to the payment and monitoring of fees for parked vehicles, both in car parks and roadside parking. It is envisaged however that the system may find application in any situation where a charge is levied for access to some area or participation in some activity. An example of an alternative use is the collection and monitoring of charges for the use of public transport or the use of public or private sports grounds or facilities.

The invention is especially useful where the charge levied is dependent on some variable criteria such as time used or, in the case of public transport or road user charges, for example, distance travelled.

### BACKGROUND TO THE INVENTION

One of the problems with levying a charge for indulging in common place activities, such as parking a vehicle, is the effort and overhead involved in collecting the fee and monitoring compliance. This is particularly so in the case of vehicle parking as in many instances it operates on a quasi-honesty system, i.e. payment points are stationed adjacent, or in the location of, vehicle parks and rely on persons using those parks to voluntarily pay a charge. Compliance is monitored by regular or random spot checks by parking wardens and additional fines levied for non compliance. The salary cost of the wardens constitutes a considerable added running cost

The disadvantage with such systems is the cost of the fee collection infrastructure, for example parking meters or coupon machines. These machines need regular attention to keep them in working order as well as to empty collected money. An additional overhead is the cost of policing compliance.

To overcome these problems pre-paid coupons are commonly used. Vehicle users can purchase a book of coupons. A coupon is removed from the book and knockouts or removable panels are manipulated to indicate the date and time of use. The coupon is displayed in the vehicle window. This system does not overcome the high cost involved in monitoring compliance, and further it is not uncommon for persons to attempt to reuse old coupons.

Another situation where a charge is levied for a common place occurrence is toll roads where it is known to make an automatic deduction of road tolls and city entrance taxes.

It is recognized that significant savings might be made by local authorities, such as parking and roading agencies, through efficiencies in fee collection and enforcement.

It is an object of the present invention to provide a system for simplifying fee collection and monitoring for chargeable activities.

It is a further object of the present invention to provide a system that ameliorates, or at least overcomes, some of the disadvantages with the prior art, or at least to provide the public with a useful alternative choice.

### SUMMARY OF THE INVENTION

According to the invention there is provided a system for the payment and monitoring of fees which includes a personal device carried by a user and activatable by the user for deduction of a payable fee by electronic payment means, the personal device having a wireless communication means for communication with a monitoring device which communicates with the personal device to confirm/ascertain that the personal device has been activated to deduct the required fee.

Preferably the electronic payment means is a smart card, or similar, inserted into the personal device.

The invention envisages that preferably, although not exclusively, a user purchases/obtains a smart card, or similar, from an organisation to whom a fee is payable, the smart card containing pre-paid credits, preferably in monetary value or the equivalent of monetary value, which can be deducted from the smart card, or similar, by the personal device on activation by the user. The user can have two or more smart cards, or similar, from different organisations, the selection of the organisation to pay being made by the user by inserting the appropriate card into the personal device before it is activated.

Preferably, the personal device has input means so that the user can input the rate at which the fee is to be paid, the monitoring device being adapted to determine that the correct rate has been entered.

In one particular embodiment the personal device is mountable in a vehicle for use in payment of parking fees. In an alternative embodiment the personal device is a hand held portable device for use in payment of public transport and/or other fees.

In further aspects of the invention there is provided a personal device and, separately, a monitoring device for use in the system for the payment and monitoring of fees.

The monitoring and/or the personal device can include a global positioning system (GPS) location-recording unit.

Preferably a single monitoring device is mounted at a location for monitoring all personal devices utilising a particular service at that location. Alternatively, the monitoring device can be a hand held device carried by monitoring persons who patrol and service an area or location where the system is used.

In another embodiment the invention can be used for the collection and monitoring of fees known as road user charges in which case a personal device can either be linked electronically to a vehicle's odometer or to an internal GPS device to measure distance travelled. The personal device can in this case be permanently mounted in the vehicle. The user can activate the personal device when travelling on roads subject to a user charge, entering the appropriate rate for the vehicle. The personal device can deduct the appropriate amount from the prepaid card based on the distance travelled.

In said another embodiment the monitoring device can be hand held, mounted beside the road or located strategically to cover large areas, and can receive transmissions from the personal device(s). The monitoring device can record that the personal device was activated and deducting an amount from the prepaid card. Where different rates of charge were possible for say, different classes of vehicle, the monitoring device can be pre-programmed to match the correct rate of deduction for a specific personal device. Where several different rates of charge are possible (for example, different rates for laden or unladen vehicles) the personal device can transmit for example the weight of the vehicle thus enabling the monitoring device to calculate the correct rate of deduction. Alternatively, enforcement agencies at the roadside can physically or visually check that the rate of deduction is correct for the vehicle and circumstances.

Further aspects of the invention will become apparent from the following descriptions which are given by way of example only.

### BRIEF DESCRIPTION OF THE DRAWINGS

The invention will now be described by way of example only and with reference to the accompanying drawings in which:

FIG. 1: illustrates a plan view of a personal device for use in a system according to the invention;

FIG. 2: illustrates a side view of the personal device of FIG. 1;

FIG. 3: illustrates a second side view of the personal device of FIG. 1; and

FIG. 4: illustrates, schematically, a monitoring device for use in a system according to the invention.

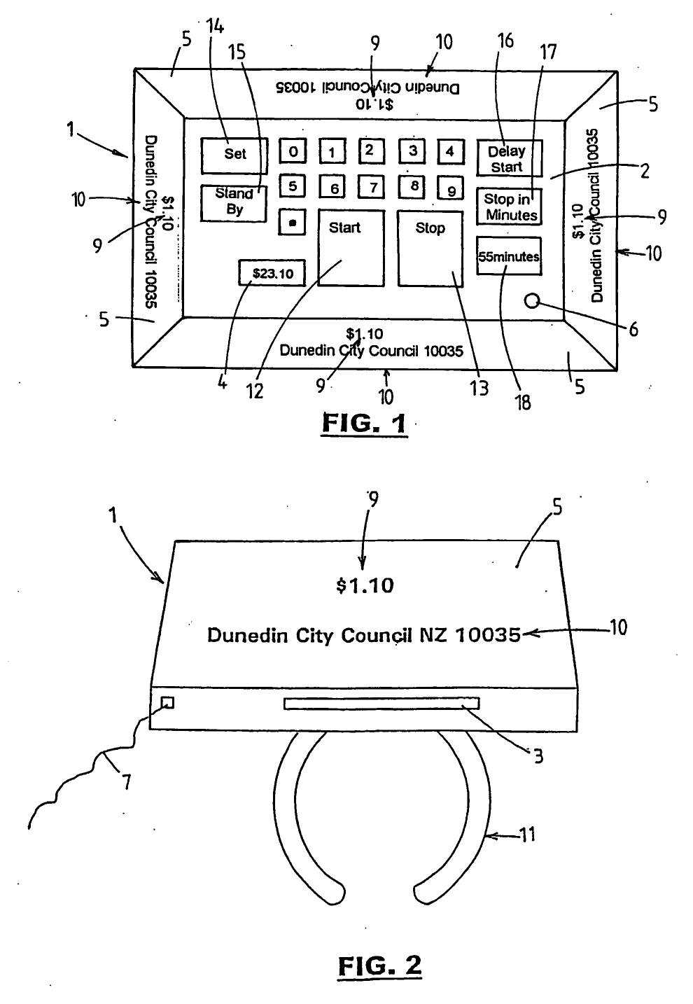

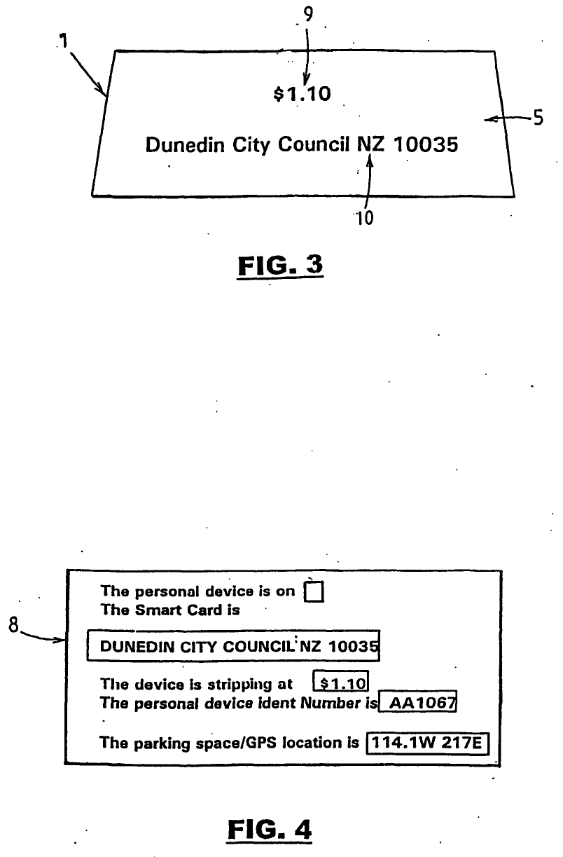

In the drawings the same reference numerals refer to like integers.

### DESCRIPTION OF THE PREFERRED EXAMPLES

To illustrate the invention it will now be described by reference to its use as a personal parking meter device. It is to be appreciated however that the invention may find application in any area where fees are levied and/or monitored such as for payment of road tolls, road user charges or the collection of fees for use of amenities.

A personal device 1 is carried by a motorist either on his or her person or in their vehicle. The personal device 1 has input means in the form of a keypad 2. The keypad 2 enables the motorist to activate the personal device 1 when they park in a designated parking space. The appropriate parking fee for the space is entered into the personal device 1, and thus it can be used at a variety of locations. A pre-purchased smart card (not shown) is inserted into the device at slot 3 (FIG. 2) and once activated the device 1 deducts the required fee from the value on the smart card. The personal device 1 can be pre-programmed, or is settable by the motorist, to meter the fee at the appropriate rate, for example hourly or daily. The device has a display 4 showing the amount, or value of credits, left on the card. Credits can be in a monetary value or alternatively some non-monetary unit.

In one embodiment of the device a GPS location-recording unit contained within the personal device, automatically records the location of the personal device.

A timing device contained within the personal device can automatically record the time elapsed since the device was switched on. The personal device can be settable by the motorist so that the device can be activated and/or deactivated automatically at a predetermined time.

Smart Cards for use in device 1 are pre-purchased and can be topped up at various outlets in an area. In one embodiment the cards are dispensed and recharged at automatic vending machines. Different authorities and organisations can issue their own cards with the user choosing, and inserting, the appropriate smart card for the authority/organisation to which the fee is payable. On purchase or top-up of the smart card money is paid to the issuing authority/organisation and thus the scheme is a type of prepaid system.

In the illustrated embodiment the personal device 1 has an electronic display 5 on each of its four sides that indicates the fee being paid 9 and the authority/organisation 10 to whom it is being paid.

The personal device 1 can be battery or solar power operated and contains all the necessary electronics to process the transaction. Such electronics are well within the capabilities of the skilled addressee. A flexible connection 7 to the motor vehicle cigarette lighter and/or battery can be added to charge the internal battery and/or run the personal device 1. In a portable embodiment the device is run solely from its internal battery. A clip 11 allows it to be mounted on the steering wheel of a car or handle bars of a motorbike.

A mains operated battery charger can be supplied. Clip 11 is a clip adapted for connection to a belt or the like or can be adapted for connection to a handlebar or steering wheel of a car, cycle or other means of transport.

In the example the keypad 2 of the personal device 1 has, in addition to display 4, the numeric keys 0 to 9 which are used by the motorist to input a required charge, start and stop keys 12,13 respectively and the additional keys as described below. A set key 14 used to power on the device to enable setting to begin and a stand-by key 15 the places the device in stand-by mode to minimise power usage over prolonged periods of non-use. Keys 16,17 which are used respectively to activate a delay start for example if the motorist parks before the start time for parking fees and early stopping for use in the situation where the motorist parks all day but fees are payable for a portion of the day. A liquid crystal display (LCD) 18 can also be incorporated in the keypad 2. The LCD 18 shows the minutes/hours to delay starting and/or stopping of the device.

An associated monitoring device 8 (FIG. 4) is available to smart card issuing authorities/organisations for monitoring payment of the fees by users of personal devices 1. The personal device 1 and monitoring device 8 have communication means for communicating with each other. This communication can be via infrared or short range radio such as ‘pulse’ radio. In the preferred embodiment monitoring device 8 is carried by parking wardens who patrol designated parking areas. As the warden passes a vehicle with a personal device 1 operating the monitoring device 8 records details of whether the personal device 1 has been activated and is deducting the correct fee from the smart card. It also collects/provides information on security features of the personal device 1 and the authority/organisation to whom the fee is being paid. The monitoring device 8 can also record the GPS location of the personal device 1 and the length of time the personal device has been activated.

It is envisaged that in one embodiment a monitoring device 8 can be placed in a prominent location and can communicate with all personal devices 1 which come within its communication range.

The monitoring device 8 can include its own GPS (global positioning system) location recording unit or it may read the GPS location from the personal device's GPS unit such that the monitoring device is able to record and match the identification number of the personal device with the location of the parking space the personal device is parked at, and also record the time and date the device was parked there. The monitoring device 8 can automatically record the location of all the personal devices it detects (and the times). When a computing and an analysing function of the monitoring device 8 detects a “match” (personal device at a location where it was previously recorded as being at) the monitoring device 8 will flash a message saying that the personal device 1 was recorded as being at this same location, say, 1½ hours ago (or at 3:30 pm) or advice to that effect. If the personal device 1 has not been activated a warden can levy a fine or penalty against the personal device or vehicle.

The location at which a personal device is located can be recorded in one or more of the following ways;
a GPS device contained within the personal device 1;
a GPS device contained within the monitoring device 8;
by manually entering a location number (unique identifier such as a number written on the curb next to the location) through a key pad on the monitoring device 8;
by using a bar code reading device contained within the monitoring device 8 to read a bar code (unique identifier) installed next to the location; or
by using a coded tag reading device contained within the monitoring device 8 which can read a coded tag (unique identifier) buried, inserted or installed next to the location.

Alternatively, it is possible to manually enter (via a number key pad not shown) into the monitoring device, the parking space number (unique identifier), and match that with the personal device 1 number and time of day. Thus if the GPS unit is not used, it will still be possible to record locations and check for matches.

When in stand-by mode (switched on, transmitting but not stripping money from the smart card) the personal device can be triggered to deduct a lump-sum amount from the smart card balance by an external device sending a signal to the personal device. When the lump sum has been deducted the personal device will “advise” the external device that the amount has been deducted. For example when a vehicle enters a city with an “entrance tax” in operation the vehicle will have the personal device in stand-by mode. When it enters the city and passes an external device on the side of the road, the personal device will deduct a lump sum, equal to the entrance tax, from the balance on the smart card. The personal device will instantaneously signal the external device that it has done so.

One advantage of the invention is that it eliminates the need for local authorities to place parking meters, or coupon machines, at or adjacent car parks and to maintain and clear money from them. It also simplifies the monitoring task as the parking warden will be automatically alerted by the monitoring unit 8 should they pass a vehicle which does not have its personal device 1 operating in the correct manner and at the correct fee rate.

Another advantage of the invention is that specific classes of motorists can be issued with unique smart cards (for example “residents only”, disabled, beneficiary etc) which allow the motorist to pay for their parking at a reduced rate.

Where in the aforegoing description reference has been made to integers having known equivalents, then such equivalents are included as if individually set forth.

Embodiments of the invention have been described by way of example only and it is envisaged that improvements and/or modifications can take place without departing from the scope of the invention as defined in the attached claims.

1. A system for the payment and monitoring of fees which includes a personal device carried by a user and activatable by the user for deduction of a payable fee by electronic payment means for a particular location, the personal device having a wireless communication means for communication with a monitoring device which communicates with the personal device to confirm/ascertain that the personal device has been activated and has or is deducting the required fee, the monitoring and/or the personal device includes a location-recording unit so that deduction of the fee is identified as being for the particular location.

2. A system as claimed in claim 1 wherein the location recording unit is a global positioning system (GPS).

3. A system as claimed in claim 1 where the monitoring device includes a coded wire tag reader or a bar code reader so that it can determine the particular location where the personal device is located by reading the coded wire or barcode located at the particular location.

4. A system as claimed in claim 1 where the monitoring device includes a key pad so that the unique number identifying the particular location can be entered by the monitoring device user to determine where the personal device is located.

5. A system as claimed in claim 1 which includes a monitoring device able to record and recall the particular location at which a personal device is/was located and is able to determine the length of time elapsed since the personal device was previously recorded as being at a particular location.

6. A system as claimed in claim 1 which includes a monitoring device which is programmable to calculate the correct rate of pre-paid credit deduction for a particular location.

7. A system as claimed in claim 6 which includes a monitoring device which can automatically compare the rate of pre-paid credit deduction being deducted by a personal device to the correct rate of deduction programmed into the monitoring device for a particular location, and automatically advise the monitoring device user whether the personal device is deducting the pre-paid credit at the correct rate for the particular location.

8. A system as claimed in claim 1 that includes a monitoring device that can automatically advise the monitoring device user, through an audible or visual signal, that the personal device it is communicating with, is operating correctly.

9. A system according to claim 8 wherein the monitoring device is able to advise the monitoring device user whether pre-paid credits are being deducted at the correct rate for the particular location the personal device is located at.

10. A system as claimed in claim 1 which includes a smart card containing a pre-paid credit and a programmed unique location code which enables a personal device user to use a particular smart card in a particular location for which they are authorized and where they are authorized to deduct pre-paid credits at a rate different to other categories of personal device users such that when the personal device communicates with the monitoring device, which has been programmed to expect a particular rate the information from the smart card causes the monitoring device to indicate to the monitoring device user that the rate was correct for that combination of personal device, smart card type and particular location.

11. A system as claimed in claim 10 wherein the user has two or more smart cards, from different organisations, the selection of the organisation to pay being made by the user by inserting the appropriate card into the personal device before it is activated.

12. A system as claimed in claim 1 wherein the personal device has input means so that the user can input the rate at which the fee is to be paid, the monitoring device being adapted to determine that the correct rate has been entered.

13. A system as claimed in claim 1 wherein the personal device is mountable in a vehicle for use in payment of parking fees.

14. A system as claimed in claim 1 wherein the personal device is a hand held portable device for use in payment of public transport and/or other fees.

15. A system as claimed in claim 1 wherein a single monitoring device is mounted at a location for monitoring all personal devices utilizing a particular service at that location.

16. A system as claimed in claim 1 wherein the monitoring device is a hand held device carried by monitoring persons who patrol and service an area or location where the system is used.

17. A system as claimed in claim 1 wherein the personal device is battery or solar power operated and contains electronic capability to process the transaction.

18. A system as claimed in claim 17 wherein a flexible connection to the motor vehicle cigarette lighter and/or battery can be used to charge the internal battery and/or run the personal device.

19. A system as claimed in claim 1 wherein a clip allows the personal device to be mounted on the steering wheel of a car or handle bars of a motorbike.

20. A system as claimed in claim 1 wherein a keypad of the personal device has a display showing the amount, or value of credits left on the card, numeric keys 0 to 9 which are used by the user to input a required charge and start and stop keys.

21. A system as claimed in claim 20 wherein the keypad has a set key used to power on the device to enable setting to begin and a stand-by key that places the device in stand-by mode to minimize power usage over prolonged periods of non-use.

22. A system as claimed in claim 21 wherein the keypad has keys which are used respectively to activate a delay start and early stopping when fees are payable for only a portion of the day.

23. A system as claimed in claim 22 wherein the keypad has a display which shows the minutes/hours to delay starting and/or stopping of the personal device.

24. A system for the collection and monitoring of fees known as road user charges in which a personal device activatable by a user for deduction of a payable fee by electronic payment means, the personal device having a wireless communication means for communication with a monitoring device which communicates with the personal device to confirm/ascertain that the personal device has been activated to deduct the required fee, the personal device being either linked electronically to a vehicle's odometer or to an internal GPS device to measure distance traveled.

25. A system as claimed in claim 24 wherein the personal device is permanently mounted in the vehicle.

26. A system as claimed in claim 24 wherein the user can activate the personal device when traveling on roads subject to a user charge, entering the appropriate rate for the vehicle.

27. A system as claimed in claim 26 wherein the personal device can deduct the appropriate amount from the prepaid card based on the distance traveled.

28. A system as claimed in claim 24 wherein the monitoring device can be hand held, mounted beside the road or located strategically to cover large areas, and is adapted to receive transmissions from the personal device.

29. A system as claimed in claim 28 wherein the monitoring device records that the personal device was activated and deducting an amount from the prepaid card.

30. A system as claimed in claim 29 wherein different rates of charge are possible for different classes of vehicle and the monitoring device is pre-programmed to match the correct rate of deduction for a specific personal device.

31. A system as claimed in claim 29 wherein several different rates of charge are possible and the personal device transmits information to the monitoring device to enable it to calculate the correct rate of deduction.

32. A system as claimed in claim 28 wherein an enforcement agency at a roadside can physically or visually check that the rate of deduction is correct for the vehicle and circumstances.

33. A system for the collection and monitoring of a fee known as an entrance fee or entrance tax, which includes a personal device carried by a user and activatable by the user for deduction of a payable fee by electronic payment means, the personal device having a wireless communication means with an external device which communicates with the personal device to confirm/ascertain that the personal device has been activated and has or is deducting the required fee, the monitoring and/or the personal device includes a location-recording unit so that deduction of a fee is made when the user passes the external device at a particular location.

34. A system as described in claim 33 wherein the personal device communicates with the external device to confirm to the external device that the personal device is operating correctly and has deducted the nominated number of pre-paid credits from a smart card.
